(19) United States
(12) Patent Application Publication
(10) Pub. No.: US 2019/0311330 A1
(43) Pub. Date: Oct. 10, 2019

(54) An Integrated Pre-Assessment Recruitment System and a Method Thereof

(71) Applicant: Reliance Industries Limited, Mumbai, Maharashtra (IN)

(72) Inventors: Ashish KUKREJA, Panipat, Haryana (IN); Harjeet Singh KHANDUJA, Navi Mumbai, Maharashtra (IN); Rahul MUKHERJEE, Navi Mumbai, Maharashtra (IN); Kaushik CHANIYARA, Navi Mumbai, Maharashtra (IN); Ramamurthy SRINIVASAN, Thane (West), Maharashtra (IN); Parul GARG, Delhi (IN); Hitesh WANKHEDE, Navi Mumbai, Maharashtra (IN); Hiten PANCHAL, Mumbai, Maharashtra (IN); Mayank GARG, Roorkee, Uttarakhand (IN); Navneet TEWANI, Vijayawada, Andhra Pradesh (IN); Mitesh Madhusudan ZAVERI, Mumbai, Maharashtra (IN); Sunil KUMTAKAR, Thane, Maharashtra (IN); Pravin Lalaso PATIL, Thane, Maharashtra (IN); Neeru Ashok BAFNA, Mumbai, Maharashtra (IN); Nitin Bhaskar JOSHI, Dombivli ? East, Thane, Maharashtra (IN); Sanjog Anand KARANDE, Mumbai, Maharashtra (IN); Tanu AGARWAL, Rajasthan (IN)

(73) Assignee: Reliance Industries Limited, Mumbai, Maharashtra (IN)

(21) Appl. No.: 16/345,547

(22) PCT Filed: Oct. 25, 2017
(86) PCT No.: PCT/IB2017/056619

§ 371 Date: Apr. 26, 2019

(30) Foreign Application Priority Data
Oct. 27, 2016 (IN) 201621036967

(51) Int. Cl. G06Q 10/10; G06Q 10/06; G09B 7/00

(52) U.S. Cl. CPC G06Q 10/1053; G09B 7/00; G06Q 10/063112

(57) ABSTRACT

The present disclosure relates to the field of recruitment systems. The system comprises a memory, an input module, a talent reader, a repository, a talent pool creation module, and a pre-offer module. The candidates provide values corresponding to tags in a pre-defined resume format to generate a resume, read by the talent reader to extract the tag values and store in candidate repository. An assessment test for the candidate based on the pre-determined questionnaires and tag values is created, and responses of the test is assessed to generate a score for filtration of candidates. A recruiter sends a set of desired tag values which are extracted and mapped with the stored tag values to generate a mapped set of candidates for sending pre-offer letters. The system create a talent pool and reduces turnaround time of the selection process.

### FIELD

The present disclosure relates to recruitment systems.

### Definitions of Terms Used in the Specification

The expression ‘Candidate’ used hereinafter in this specification refers to a person who is seeking the job in an organization.

The expression ‘Assessment Test’ used hereinafter in this specification refers to the test taken by the candidates for assessing the candidates. The assessment test may include multiple choices test, text based test, programming test, typing test and the like.

The expression ‘User Device’ used hereinafter in the specification refers to a device, used by the user, wherein the user device includes, but is not limited to, a mobile phone, a laptop, a tablet, an iPad, a PDA, a notebook, a net book, a smart device, a smart phone, a personal computer.

These definitions are in addition to those expressed in the art.

### BACKGROUND

A recruitment process in any organization, typically begins when a position is released for recruitment, i.e., in case of a vacancy. On release of a vacant position, the recruiter gets an intimation to start a selection process. The selection process usually includes searching suitable candidates, checking interests, conducting test(s)/interview(s) for the candidates, and completing their assessments. On completion of these stages, a relevant candidate is selected and an offer is made. If the candidate agrees to the terms of employment, pre-joining formalities and other verification checks are carried out. The candidate is on-boarded finally on successful completion of the above mentioned process, and the vacant position is closed.

This conventional recruitment process happens sequentially and requires a turnaround time of approximately 60 days for selection. As the selection process starts only after release of a vacant position, the position remains vacant throughout the selection process thereby impacting the business. Such impact is significantly greater in case of positions, with high attrition, that require customer interactions.

Therefore, there is felt a need to limit the aforementioned drawbacks and provide a system for recruitment which reduces turnaround time of the selection process.

### OBJECTS

Some of the objects of the present disclosure which at least one embodiment herein satisfies, are as follows:

An object of the present disclosure is to provide an integrated pre-assessment recruitment system and a method thereof.

Another object of the present disclosure is to provide the system for creating a pipeline of candidates for anticipated requirement(s).

Yet another object of the present disclosure is to provide the system for assessing the candidates for recruitment purposes and create a talent pool.

Still another object of the present disclosure is to provide the system for verifying documents of selected candidates.

An object of the present disclosure is to provide the system which reduces the risk of proxy recruitment.

Another object of the present disclosure is to provide the system which operates seamlessly, irrespective of different locations and verticals of an organization.

Still another object of the present disclosure is to provide the system which enables recruiters to share candidate pools with each other.

Yet another object of the present disclosure is to provide the system which reduces turnaround time of the selection process.

Other objects and advantages of the present disclosure will be more apparent from the following description when read in conjunction with the accompanying figures, which are not intended to limit the scope of the present disclosure.

### SUMMARY

The present disclosure envisages an integrated pre-assessment recruitment system. The system comprises a memory, an input module, a talent reader, a repository, a talent pool creation module, and a pre-offer module.

The memory is configured to store a pre-defined resume format. The pre-defined resume format comprising a plurality of bibliographic tags and skill tags.

The input module is configured to cooperate with the memory to receive the pre-defined resume format, and is further configured to facilitate:
at least one candidate to provide values corresponding to the bibliographic tags and the skill tags in the pre-defined resume format, and further configured to generate a resume for the candidate based on the received tag values; and
at least one recruiter to provide at least one set of desired tag values that includes at least one desired bibliographic tag value and at least one desired skill tag value corresponding to a vacant post.

The talent reader is configured to cooperate with the input module to read through each of the generated resumes, and further configured to extract values corresponding to the bibliographic tags and the skill tags associated with resumes of each of the candidate.

The talent reader includes a crawler and extractor, and a tagging module.

The crawler and extractor is configured to cooperate with the input module to receive the generated resumes, and further configured to read through each of the generated resumes to extract values corresponding to the bibliographic tags and the skill tags associated with resumes of each of the candidate. The tagging module is configured to cooperate with the crawler and extractor to store the extracted bibliographic details and the extracted skill details corresponding to each of the associated tags in the candidate repository.

The repository is configured to cooperate with the talent reader. The repository comprising:
a candidate repository configured to store values corresponding to the bibliographic tags and the skill tags associated with each of the candidate; and
a temporary repository configured to store a set of pre-determined questionnaires.

The talent pool creation module is configured to cooperate with the repository to create an assessment test for the candidate based on the pre-determined questionnaires and values corresponding to the skill tags associated with each of the candidate and transmit the assessment test to the candidate based on the bibliographic tags associated with each of the candidate. The talent pool creation module is further configured to receive and assess responses for the created tests to generate a score for each of the candidates. The talent pool creation module is configured to filter the candidate based on the generated assessment scores.

The talent pool creation module includes a test creation module, an assessment scoring module, and a talent filtration module.

The test creation module is configured to cooperate with the repository to create the assessment test for the candidate based on the pre-determined questionnaires and values corresponding to the skill tags associated with each of the candidate, and is further configured to transmit the assessment test to the candidate based on the bibliographic tags associated with each of the candidate.

The assessment scoring module is configured to cooperate with the test creation module to receive the assessment test response corresponding to the assessment tests, and is further configured to assess the assessment test response to generate a score for each of the candidates.

The talent filtration module is configured to cooperate with the assessment scoring module to filter the candidate based on the generated assessment scores.

The pre-offer module is configured to cooperate with the talent pool creation module and the repository to map the set of desired tag values provided by the recruiter with the tag values of the filtered candidates stored in the candidate repository to generate a set of mapped candidates. The pre-offer module is further configured to generate pre-offer letters for each of the mapped candidates.

The pre-offer module includes a vacancy receiving module, a multiple crawler and extractor, and an assessment module.

The vacancy receiving module is configured to cooperate with the input module to receive the set of desired tag values that includes the desired bibliographic tag value and the desired skill tag value corresponding to the vacant post.

The multiple crawler and extractor is configured to cooperate with the vacancy receiving module and the repository to crawl multiple times through the candidate repository to map the set of desired tag values with the tag values of the filtered candidates stored in the candidate repository to generate the set of mapped candidates.

The assessment module is configured to cooperate with the multiple crawler and extractor to generate the pre-offer letter corresponding to the set of mapped candidates.

In an embodiment, on an event of rejection of the pre-offer letter by the candidate, the bibliographic details and the skill details associated with each of the candidate is deleted from the candidate repository.

In another embodiment, the bibliographic tags include name, address, email id, photograph, interests, preference, current location, unique identification number, and the skill tags include education details, prior-employment information, current employment details, years of experience, and qualification.

In an embodiment, the talent reader, the talent pool creation module and the pre-offer module are implemented using one or more processor(s).

The present disclosure also envisages a method for integrating pre-assessment recruitment processes. The method comprising:
storing, by a memory, a pre-defined resume format, the pre-defined resume format comprising a plurality of bibliographic tags and skill tags;
receiving, by an input module, the pre-defined resume format;
providing, by the input module, values corresponding to the bibliographic tags and the skill tags in the pre-defined resume format by a candidate;
generating, by the input module, a resume for the candidate based on the received tag values;
providing, by the input module, at least one set of desired tag values that includes at least one desired bibliographic tag value and at least one desired skill tag value corresponding to a vacant post by at least one recruiter;
reading, by a talent reader, through each of the generated resumes;
extracting, by the talent reader, values corresponding to the bibliographic tags and the skill tags associated with resumes of each of the candidate;
storing, by a repository, a candidate repository configured to store values corresponding to the bibliographic tags and the skill tags associated with each of the candidate, and a temporary repository configured to store a set of pre-determined questionnaires;
creating, by a talent pool creation module, an assessment test for the candidate based on the pre-determined questionnaires and values corresponding to the skill tags associated with each of the candidate;
transmitting, by the talent pool creation module, the assessment test to the candidate based on the bibliographic tags associated with each of the candidate;
assessing, by the talent pool creation module, received responses for the created tests to generate a score for each of the candidates;
filtering, by the talent pool creation module, the candidate based on the generated assessment scores;
mapping, by a pre-offer module, the set of desired tag values provided by the recruiter with the tag values of the filtered candidates stored in the candidate repository to generate a set of mapped candidates; and
generating, by the pre-offer module, pre-offer letters for each of the mapped candidates.

### BRIEF DESCRIPTION OF THE ACCOMPANYING DRAWING

An integrated pre-assessment recruitment system and a method thereof of the present disclosure will now be described with the help of the accompanying drawing, in which:

FIG. 1 illustrates a block diagram of an integrated pre-assessment recruitment system; and

FIGS. 2a, 2b and 2c illustrate a flow diagram for a method of integrated pre-assessment recruitment.

### LIST OF REFERENCE NUMERALS

| Reference | |
|---|---|
| Numeral | Reference |
| 100 | integrated pre-assessment |
| | and recruitment system |
| 102 | memory |
| 104 | input module |
| 106 | talent reader |
| 108 | repository |
| 108a | candidate repository |
| 108b | temporary repository |
| 110 | talent pool creation module |
| 112 | pre-offer module |
| 114 | crawler and extractor |
| 116 | tagging module |
| 118 | test creation module |
| 120 | assessment scoring module |
| 122 | talent filtration module |
| 124 | vacancy receiving module |
| 126 | multiple crawler and extractor |
| 128 | assessment module |

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units and/or components, but do not forbid the presence or addition of one or more other features, elements, components, and/or groups thereof.

The conventional recruitment process requires a turnaround time of approximately 60 days for recruiting a candidate. The recruitment process starts only after release of a vacant position, and the position remains vacant throughout the recruitment process thereby impacting the work at organization. Therefore, there is felt a need of system and method which the present disclosure envisages an automated onboarding system and method which facilitates creation of talent pool by pre-assessment and reduces the turnaround time to one day.

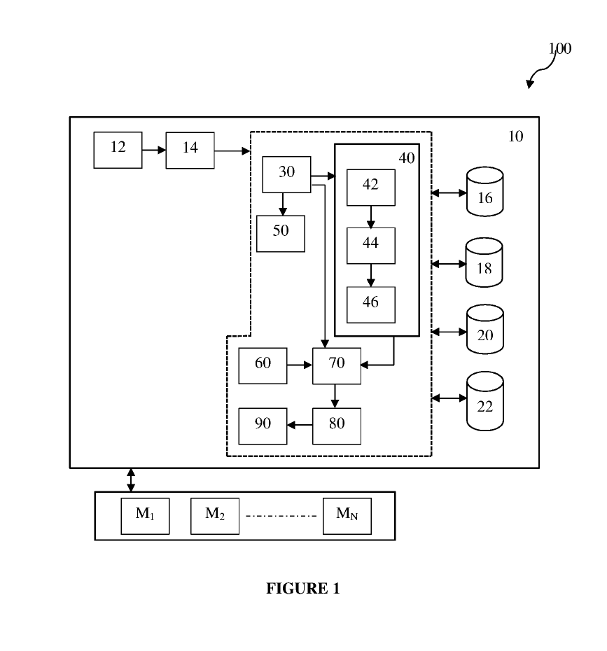

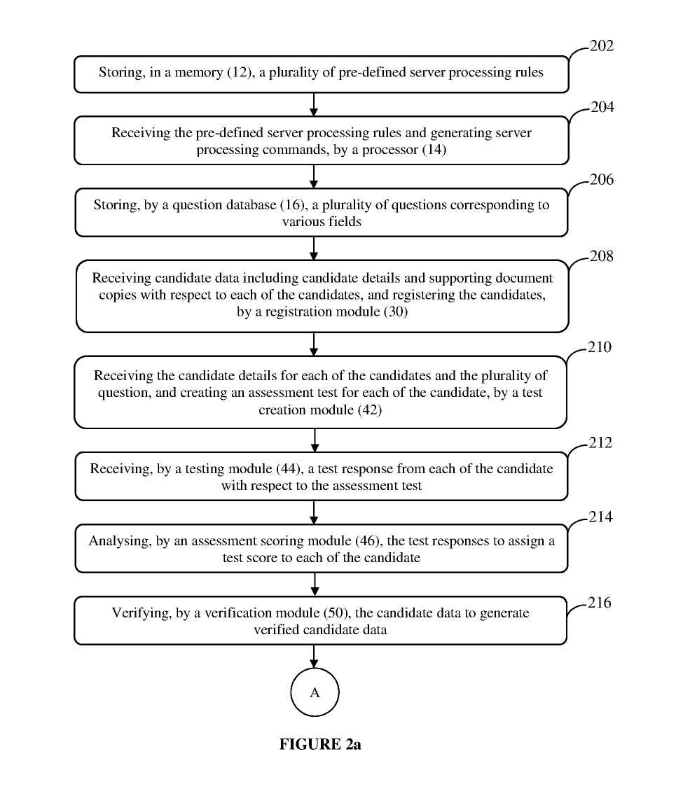

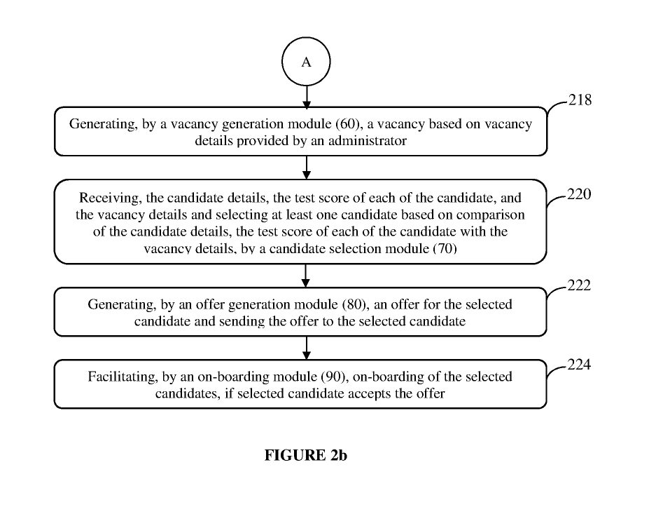

An integrated pre-assessment recruitment system and a method thereof of the present disclosure, is described with reference to FIG. 1 through FIG. 2c.

Referring to FIG. 1 the integrated pre-assessment recruitment system (hereinafter referred as “system”) (100) comprises a memory (102), an input module (104), a talent reader (106), a repository (108), a talent pool creation module (110), and a pre-offer module (112).

The memory (102) is configured to store a pre-defined resume format. The pre-defined resume format comprising a plurality of bibliographic tags and skill tags. The memory (102) may include any computer-readable medium known in the art including, for example, volatile memory, such as static random access memory (SRAM) and dynamic random access memory (DRAM), and/or a non-volatile memory, such as read only memory (ROM), erasable programmable ROM, flash memories, hard disks, optical disks, and magnetic tapes.

The input module (104) is configured to cooperate with the memory (102) to receive the pre-defined resume format, and is further configured to facilitate:
at least one candidate to provide values corresponding to the bibliographic tags and the skill tags in the pre-defined resume format, and further configured to generate a resume for the candidate based on the received tag values; and
at least one recruiter to provide at least one set of desired tag values that includes at least one desired bibliographic tag value and at least one desired skill tag value corresponding to a vacant post.

In an embodiment, the candidate and the recruiter provide the inputs through a user device.

In an embodiment, the candidate register to the system (100) and fill the tags. The registration module (not shown in figures) is integrated with multiple sourcing channels for creating talent pool having the candidate data of multiple candidates. The multiple sourcing channels includes: (a) careers website (b) integrated posting to job boards (c) integrated allocation to external partners—NGOs (d) integrated allocation to empaneled external search partners (e) employee referrals (f) social media postings (g) integrated empaneled colleges (h) integrated posting to alumni portal. In an embodiment, the registration module also captures IP address, latitude and longitude of the candidate's user device to identify the validity of location.

In another embodiment, using the registration module the candidate can update the tag values periodically or at pre-defined intervals which enable the candidate to keep their profile updated.

The talent reader (106) is configured to cooperate with the input module (104) to read through each of the generated resumes, and is further configured to extract values corresponding to the bibliographic tags and the skill tags associated with resumes of each of the candidate.

The talent reader includes a crawler and extractor (114), and a tagging module (116).

The crawler and extractor (114) is configured to cooperate with the input module (104) to receive the generated resumes, and is further configured to read through each of the generated resumes to extract values corresponding to the bibliographic tags and the skill tags associated with resumes of each of the candidate.

An exemplified pseudocode for the crawler and extractor (114) is given below:

Program (crawler and extractor)

Read received generated resumes

Do

{

extract values corresponding to the bibliographic
tags and the skill tags associated with resumes of
each of the candidate.

} While (Read received generated resumes)

End

The tagging module (116) is configured to cooperate with the crawler and extractor (114) to store the extracted bibliographic details and the extracted skill details corresponding to each of the associated tags in the candidate repository (108a).

An exemplified pseudocode for the tagging module (116) is given below:

Program (tagging)

Read extracted bibliographic details and the extracted skill details

Do

{

store the extracted bibliographic details and the
extracted skill details corresponding to each of the
associated tags in the candidate repository (108a).

} While (Read extracted bibliographic details and the extracted
skill details)

End

The repository (108) is configured to cooperate with the talent reader (106). The repository (108) comprising:
a candidate repository (108a) configured to store values corresponding to the bibliographic tags and the skill tags associated with each of the candidate; and
a temporary repository (108b) configured to store a set of pre-determined questionnaires.

In an embodiment, the set of pre-determined questionnaires corresponds to various domains.

The talent pool creation module (110) is configured to cooperate with the repository (108) to create an assessment test for the candidate based on the pre-determined questionnaires and values corresponding to the skill tags associated with each of the candidate and transmit the assessment test to the candidate based on the bibliographic tags associated with each of the candidate. The talent pool creation module (110) is further configured to receive and assess responses for the created tests to generate a score for each of the candidates. The talent pool creation module (110) is configured to filter the candidate based on the generated assessment scores.

The talent pool creation module (110) includes a test creation module (118), an assessment scoring module (120), and a talent filtration module (122).

The test creation module (118) is configured to cooperate with the repository (108) to create the assessment test for the candidate based on the pre-determined questionnaires and values corresponding to the skill tags associated with each of the candidate, and is further configured to transmit the assessment test to the candidate based on the bibliographic tags associated with each of the candidate.

An exemplified pseudocode for the test creation module (118) is given below:

Program (test creation)

Read the pre-determined questionnaires and values corresponding
to the skill tags associated with each of the candidate.

Do

{

create the assessment test for the candidate;
transmit the assessment test to the candidate based on
the bibliographic tags associated with each of the
candidate.

} While (Read the pre-determined questionnaires and

values corresponding to the skill tags associated
with each of the candidate)

End

The assessment scoring module (120) is configured to cooperate with the test creation module (118) to receive the assessment test response corresponding to the assessment tests, and is further configured to assess the assessment test response to generate a score for each of the candidates.

An exemplified pseudocode for the assessment scoring module (120) is given below:

Program (assessment scoring)

Read assessment test response corresponding to the assessment tests

Do

{

assess the assessment test response to generate a score
for each of the candidates.
} While (Read assessment test response corresponding
to the assessment tests)

End

The talent filtration module (122) is configured to cooperate with the assessment scoring module (120) to filter the candidate based on the generated assessment scores.

An exemplified pseudocode for the talent filtration module (122) is given below:

Program (talent filtration)

Read assessment scoring

Do

{

filter the candidate based on the generated assessment
scores.
} While (Read assessment scoring)

End

The pre-offer module (112) is configured to cooperate with the talent pool creation module (110) and the repository (108) to map the set of desired tag values provided by the recruiter with the tag values of the filtered candidates stored in the candidate repository (108a) to generate a set of mapped candidates. The pre-offer module (112) is further configured to generate pre-offer letters for each of the mapped candidates.

The pre-offer module (112) includes a vacancy receiving module (124), a multiple crawler and extractor (126), and an assessment module (128).

The vacancy receiving module (124) is configured to cooperate with the input module (104) to receive the set of desired tag values that includes the desired bibliographic tag value and the desired skill tag value corresponding to the vacant post.

An exemplified pseudocode for the vacancy receiving module (124) is given below:

Program (vacancy receiving)

Read receive the set of desired tag values.

End

The multiple crawler and extractor (126) is configured to cooperate with the vacancy receiving module (124) and the repository (108) to crawl multiple times through the candidate repository (108a) to map the set of desired tag values with the tag values of the filtered candidates stored in the candidate repository (108a) to generate the set of mapped candidates.

An exemplified pseudocode for the multiple crawler and extractor (126) is given below:

Program (multiple crawler and extractor)

Read tag values of the filtered candidates stored in the candidate
repository (108a), set of desired tag values

Do

{

crawl multiple times through the candidate repository
(108a) to map the set of desired tag values with the tag
values of the filtered candidates stored in the candidate
repository (108a); generate the set of mapped
candidates.
} While (Read tag values of the filtered candidates
stored in the candidate repository (108a), set of desired
tag values)

End

The assessment module (128) is configured to cooperate with the multiple crawler and extractor (126) to generate the pre-offer letter corresponding to the set of mapped candidates.

An exemplified pseudocode for the assessment module (128) is given below:

Program (assessment module)

Read set of mapped candidates

Do

{

generate the pre-offer letter corresponding to the
set of mapped candidates.

} While (Read set of mapped candidates)

End

In an embodiment, on an event of rejection of the pre-offer letter by the candidate, the bibliographic details and the skill details associated with each of the candidate is deleted from the candidate repository (108a).

In another embodiment, the bibliographic tags include name, address, email id, photograph, interests, preference, current location, unique identification number, and the skill tags include education details, prior-employment information, current employment details, years of experience, and qualification.

In an embodiment, the talent reader (106), the talent pool creation module (110) and the pre-offer module (112) are implemented using one or more processor(s).

The processor may be implemented as one or more microprocessors, microcomputers, microcontrollers, digital signal processors, central processing units, state machines, logic circuitries, and/or any devices that manipulate signals based on operational instructions. Among other capabilities, the processor may be configured to fetch and execute computer-readable instructions that may be stored in the memory (102).

FIGS. 2a, 2b, and 2c illustrate a flow diagram for a method of integrated pre-assessment recruitment.

The steps include:
Step 202: storing, by a memory (102), a pre-defined resume format, the pre-defined resume format comprising a plurality of bibliographic tags and skill tags;
Step 204: receiving, by an input module (104), the pre-defined resume format;
Step 206: providing, by the input module (104), values corresponding to the bibliographic tags and the skill tags in the pre-defined resume format by a candidate;
Step 208: generating (208), by the input module (104), a resume for the candidate based on the received tag values;
Step 210: providing, by the input module (104), at least one set of desired tag values that includes at least one desired bibliographic tag value and at least one desired skill tag value corresponding to a vacant post by at least one recruiter;
Step 212: reading, by a talent reader (106), through each of the generated resumes;
Step 214: extracting, by the talent reader (106), values corresponding to the bibliographic tags and the skill tags associated with resumes of each of the candidate;
Step 216: storing, by a repository (108), a candidate repository configured to store values corresponding to the bibliographic tags and the skill tags associated with each of the candidate, and a temporary repository configured to store a set of pre-determined questionnaires;
Step 218: creating, by a talent pool creation module (110), an assessment test for the candidate based on the pre-determined questionnaires and values corresponding to the skill tags associated with each of the candidate;
Step 220: transmitting, by the talent pool creation module (110), the assessment test to the candidate based on the bibliographic tags associated with each of the candidate;
Step 222: assessing, by the talent pool creation module (110), received responses for the created tests to generate a score for each of the candidates;
Step 224: filtering, by the talent pool creation module (110), the candidate based on the generated assessment scores;
Step 226: mapping, by a pre-offer module (112), the set of desired tag values provided by the recruiter with the tag values of the filtered candidates stored in the candidate repository to generate a set of mapped candidates; and
Step 228: generating, by the pre-offer module (112), pre-offer letters for each of the mapped candidates.

### Technical Advancements

The present disclosure described herein above has several technical advantages including, but not limited to, the realization of an integrated pre-assessment recruitment system and a method thereof, which:
creates a pipeline of candidates for anticipated requirement(s);
assesses the candidates for recruitment purposes and create the talent pool;
verifies documents of selected candidates;
reduces the risk of proxy recruitment;
operates seamlessly, irrespective of different locations and verticals of an organization;
enables recruiters to share candidate pools with each other; and
reduces turnaround time of the selection process.

The foregoing disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a step, or group of steps, but not the exclusion of any other step, or group of steps.

The use of the expression “at least” or “at least one” suggests the use of one or more elements or quantities, as the use may be in the embodiment of the disclosure to achieve one or more of the desired objects or results.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1-8. (canceled)

9. An integrated pre-assessment recruitment system, said system (100) comprising:
a memory (102) configured to store a pre-defined resume format, said pre-defined resume format comprising a plurality of bibliographic tags and skill tags;
an input module (104) configured to cooperate with said memory (102) to receive said pre-defined resume format, and further configured to facilitate:
at least one candidate to provide values corresponding to said bibliographic tags and said skill tags in said pre-defined resume format, and further configured to generate a resume for said candidate based on said received tag values; and
at least one recruiter to provide at least one set of desired tag values that includes at least one desired bibliographic tag value and at least one desired skill tag value corresponding to a vacant post,
a talent reader (106) configured to cooperate with said input module (104) to read through each of said generated resumes, and further configured to extract values corresponding to said bibliographic tags and said skill tags associated with resumes of each of said candidate;
a repository (108) configured to cooperate with said talent reader (106), said repository (108) comprising:
a candidate repository (108a) configured to store values corresponding to said bibliographic tags and said skill tags associated with each of said candidate; and
a temporary repository (108b) configured to store a set of pre-determined questionnaires,
a talent pool creation module (110) configured to cooperate with said repository (108) to create an assessment test for said candidate based on said pre-determined questionnaires and values corresponding to said skill tags associated with each of said candidate and transmit said assessment test to said candidate based on said bibliographic tags associated with each of said candidate, said talent pool creation module (110) further configured to receive and assess responses for said created tests to generate a score for each of said candidates, said talent pool creation module (110) configured to filter said candidate based on said generated assessment scores; and
a pre-offer module (112) configured to cooperate with said talent pool creation module (110) and said repository (108) to map said set of desired tag values provided by said recruiter with said tag values of said filtered candidates stored in said candidate repository (108a) to generate a set of mapped candidates, said pre-offer module (112) further configured to generate pre-offer letters for each of said mapped candidates,
wherein said talent reader (106), said talent pool creation module (110) and said pre-offer module (112) are implemented using one or more processor(s).

10. The system (100) as claimed in claim 9, wherein said talent reader (106) comprises:
a crawler and extractor (114) configured to cooperate with said input module (104) to receive said generated resumes, and further configured to read through each of said generated resumes to extract values corresponding to said bibliographic tags and said skill tags associated with resumes of each of said candidates; and
a tagging module (116) configured to cooperate with said crawler and extractor (114) to store said extracted bibliographic details and said extracted skill details corresponding to each of said associated tags in said candidate repository (108a).

11. The system (100) as claimed in claim 9, wherein said talent pool creation module (110) comprises:
a test creation module (118) configured to cooperate with said repository (108) to create said assessment test for said candidate based on said pre-determined questionnaires and values corresponding to said skill tags associated with each of said candidate, and further configured to transmit said assessment test to said candidate based on said bibliographic tags associated with each of said candidate;
an assessment scoring module (120) configured to cooperate with said test creation module (118) to receive said assessment test response corresponding to said assessment tests, and further configured to assess said assessment test response to generate a score for each of said candidates; and
a talent filtration module (122) configured to cooperate with said assessment scoring module (120) to filter said candidate based on said generated assessment scores.

12. The system (100) as claimed in claim 9, wherein said pre-offer module (112) comprises:
a vacancy receiving module (124) configured to cooperate with said input module (104) to receive said set of desired tag values that includes said desired bibliographic tag value and said desired skill tag value corresponding to said vacant post;
a multiple crawler and extractor (126) configured to cooperate with said vacancy receiving module (124) and said repository (108) to crawl multiple times through said candidate repository (108a) to map said set of desired tag values with said tag values of said filtered candidates stored in said candidate repository (108a) to generate said set of mapped candidates; and
an assessment module (128) configured to cooperate with said multiple crawler and extractor (126) to generate said pre-offer letter corresponding to said set of mapped candidates.

13. The system as claimed in claim 12, wherein on an event of rejection of said pre-offer letter by said candidate, said bibliographic details and said skill details associated with each of said candidate is deleted from said candidate repository (108a).

14. The system as claimed in claim 9, wherein said bibliographic tags include name, address, email id, photograph, interests, preference, current location, unique identification number, and said skill tags include education details, prior-employment information, current employment details, years of experience, and qualification.

15. A method for integrated pre-assessment recruitment, said method comprises the following steps:
storing (202), by a memory (102), a pre-defined resume format, said pre-defined resume format comprising a plurality of bibliographic tags and skill tags;
receiving (204), by an input module (104), said pre-defined resume format;
providing (206), by said input module (104), values corresponding to said bibliographic tags and said skill tags in said pre-defined resume format by a candidate,
generating (208), by said input module (104), a resume for said candidate based on said received tag values;
providing (210), by said input module (104), at least one set of desired tag values that includes at least one desired bibliographic tag value and at least one desired skill tag value corresponding to a vacant post by at least one recruiter;
reading (212), by a talent reader (106), through each of said generated resumes;
extracting (214), by said talent reader (106), values corresponding to said bibliographic tags and said skill tags associated with resumes of each of said candidate;
storing (216), by a repository (108), a candidate repository configured to store values corresponding to said bibliographic tags and said skill tags associated with each of said candidate, and a temporary repository configured to store a set of pre-determined questionnaires;
creating (218), by a talent pool creation module (110), an assessment test for said candidate based on said pre-determined questionnaires and values corresponding to said skill tags associated with each of said candidate;
transmitting (220), by said talent pool creation module (110), said assessment test to said candidate based on said bibliographic tags associated with each of said candidate
assessing (222), by said talent pool creation module (110), received responses for said created tests to generate a score for each of said candidates;
filtering (224), by said talent pool creation module (110), said candidate based on said generated assessment scores;
mapping (226), by a pre-offer module (112), said set of desired tag values provided by said recruiter with said tag values of said filtered candidates stored in said candidate repository to generate a set of mapped candidates; and
generating (228), by said pre-offer module (112), pre-offer letters for each of said mapped candidates.
